(19) United States
(12) Patent Application Publication
(10) Pub. No.: US 2017/0207659 A1
(43) Pub. Date: Jul. 20, 2017

(54) METHOD AND APPARATUS FOR COEXISTENCE BETWEEN COMMUNICATION AND WIRELESS POWER TRANSFER DEVICES

(71) Applicant: QUALCOMM Incorporated, San Diego, CA (US)

(72) Inventors: Mahbod Mofidi, San Diego, CA (US); Ashish Banthia, San Diego, CA (US); Seong Heon Jeong, San Diego, CA (US); Paul Brandon Butler, San Jose, CA (US)

(21) Appl. No.: 15/190,598

(22) Filed: Jun. 23, 2016

Related U.S. Application Data
(60) Provisional application No. 62/278,787, filed on Jan. 14, 2016.

(51) Int. Cl. H02J 50/12; H02J 50/80; H02J 7/02

(52) U.S. Cl. CPC H02J 50/12; H02J 7/025; H02J 50/80

(57) ABSTRACT

An apparatus for wirelessly transmitting charging power is provided. The apparatus comprises a transmit coil configured to generate a wireless charging field for wirelessly transmitting charging power when driven by a current. The apparatus comprises a control circuit configured to cause the transmit coil to transmit a packet via the wireless charging field, wherein the packet comprises information indicative of the presence of the wireless charging field to cause a chargeable device to electrically disconnect a communication circuit from a receive coil within the chargeable device. The control circuit is further configured to cause the transmit coil to transmit the packet periodically based on a predetermined interval. The predetermined interval has a shorter duration than a duration of a communication interval of the communication circuit. The control circuit is further configured to reduce a magnitude of a strength of the wireless charging field during packet transmission.

### PRIORITY CLAIM

This application claims the benefit of U.S. Provisional Application No. 62/278,787, filed Jan. 14, 2016, which is hereby incorporated herein by reference in its entirety.

### FIELD

This application is generally related to wireless power transfer, and more specifically to methods and apparatuses for coexistence between communication and wireless power transfer devices.

### BACKGROUND

Some electrical devices today are equipped with the ability to receive charging power wirelessly as well as to communicate using communication protocols such as NFC. However, wireless charging fields that provide wireless charging power may also induce dangerously high voltages in communication circuitry of these electrical devices, which may cause damage. Accordingly, apparatuses and methods that reduce or eliminate the potential for such damage to the communication circuitry of these electrical devices are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the present disclosure provides an apparatus for wirelessly transmitting charging power. The apparatus includes a transmit coil configured to generate a wireless charging field for wirelessly transmitting charging power when driven by a current. The apparatus further includes a control circuit configured to modulate the wireless charging field for transmission of a packet via the wireless charging field. The packet includes information indicative of the presence of the wireless charging field to cause a chargeable device to electrically disconnect a communication circuit from a receive coil within the chargeable device. The transmit coil is further configured to transmit the packet via the wireless charging field.

In various embodiments, the control circuit can be further configured to cause the transmit coil to transmit the packet periodically based on a predetermined interval. In various embodiments, the predetermined interval can have a shorter duration than a duration utilized by the communication circuit to send a communication command and wait to receive a reply in response to the communication command. In various embodiments, the wireless charging field can oscillate at a fundamental frequency and can carry sufficient energy at a harmonic of the fundamental frequency for the chargeable device to accurately identify the packet at the harmonic of the fundamental frequency.

In various embodiments, the control circuit can be further configured to cause the transmit coil to transmit the packet as an amplitude shift keying modulation of the wireless charging field. In various embodiments, the packet can include a first portion having a length of 8 bits and a parity bit appended to the end of the first portion. In various embodiments, the control circuit can be further configured to reduce a magnitude of a strength of the wireless charging field during packet transmission.

Another aspect provides a method for wirelessly transmitting charging power. The method includes generating a wireless charging field for wirelessly transmitting power. The method further includes modulating the wireless charging field for transmission of a packet via the wireless charging field. The packet includes information indicative of the presence of the wireless charging field to cause a chargeable device to electrically disconnect a communication circuit from a receive coil within the chargeable device. The method further includes transmitting the packet via the wireless charging field.

In various embodiments, the packet can be transmitted periodically based on a predetermined interval. In various embodiments, the predetermined interval can have a shorter duration than a duration utilized by the communication circuit to send a communication command and wait to receive a reply in response to the communication command. In various embodiments, the wireless charging field can oscillate at a fundamental frequency and can carry sufficient energy at a harmonic of the fundamental frequency for the chargeable device to accurately identify the packet at the harmonic of the fundamental frequency.

In various embodiments, transmitting the packet via the wireless charging field can include modulating the wireless charging field using amplitude shift keying modulation. In various embodiments, the packet can include a first portion having a length of 8 bits and a parity bit appended to the end of the first portion. In various embodiments, the method can further include reducing a magnitude of a strength of the wireless charging field while transmitting the packet.

Another aspect provides a non-transitory computer-readable medium. The medium includes code that, when executed, causes an apparatus, for wirelessly transmitting charging power, to generate a wireless charging field for wirelessly transmitting power. The medium further includes code that, when executed, causes the apparatus to modulate the wireless charging field for transmission of a packet via the wireless charging field. The packet includes information indicative of the presence of the wireless charging field to cause a chargeable device to electrically disconnect a communication circuit from a receive coil within the chargeable device. The medium further includes code that, when executed, causes the apparatus to transmit the packet via the wireless charging field.

In various embodiments, the medium further can further include code that, when executed, causes the apparatus to transmit the packet periodically based on a predetermined interval. In various embodiments, the predetermined interval can have a shorter duration than a duration utilized by the communication circuit to send a communication command and wait to receive a reply in response to the communication command. In various embodiments, the wireless charging field can oscillate at a fundamental frequency and can carry sufficient energy at a harmonic of the fundamental frequency for the chargeable device to accurately identify the packet at the harmonic of the fundamental frequency.

In various embodiments, the medium further can further include code that, when executed, causes the apparatus to transmit the packet as an amplitude shift keying modulation of the wireless charging field. In various embodiments, packet can include a first portion having a length of 8 bits and a parity bit appended to the end of the first portion. In various embodiments, the medium further can further include code that, when executed, causes the apparatus to reduce a magnitude of a strength of the wireless charging field while transmitting the packet.

Another aspect provides another apparatus for wirelessly transmitting charging power. The apparatus includes means for generating a wireless charging field for wirelessly transmitting charging power. The apparatus further includes means for modulating the wireless charging field for transmission of a packet via the wireless charging field. The packet includes information indicative of the presence of the wireless charging field to cause a chargeable device to electrically disconnect a communication circuit from a receive coil within the chargeable device. The apparatus further includes means for transmitting the packet via the wireless charging field.

In various embodiments, the apparatus can further include means for transmitting the packet periodically based on a predetermined interval. In various embodiments the predetermined interval can have a shorter duration than a duration utilized by the communication circuit to send a communication command and wait to receive a reply in response to the communication command. In various embodiments the wireless charging field can oscillate at a fundamental frequency and can carry sufficient energy at a harmonic of the fundamental frequency for the chargeable device to accurately identify the packet at the harmonic of the fundamental frequency.

In various embodiments, the means for transmitting the packet can be configured to transmit the packet as an amplitude shift keying modulation of the wireless charging field. In various embodiments, the packet can include a first portion having a length of 8 bits and a parity bit appended to the end of the first portion. In various embodiments, the apparatus can further include means for reducing a magnitude of a strength of the wireless charging field during packet transmission.

Another aspect provides another apparatus for coexistence with a wireless power transmitter. The apparatus includes a control circuit configured to detect a packet transmitted by the wireless power transmitter via modulation of a wireless power charging field. The packet indicates presence of the wireless charging field. The control circuit is further configured to identify the presence of the wireless charging field based on detecting the packet. The apparatus further includes a switching circuit configured to electrically disconnect a communication circuit from a receive coil in response to identifying the presence of the wireless charging field.

In various embodiments, the control circuit can cause the switching circuit to electrically disconnect the communication circuit from the receive coil in response to identifying the presence of the wireless charging field. In various embodiments, packet can include an amplitude shift keying modulation of the wireless charging field. In various embodiments, the packet can include a first portion having a length of 8 bits and a parity bit appended to the end of the first portion.

In various embodiments, the switching circuit can be configured to electrically connect the communication circuit to the receive coil in an initial state. In various embodiments, the wireless charging field can oscillate at a fundamental frequency and can carry sufficient energy at a harmonic of the fundamental frequency for the control circuit to accurately identify the presence of the wireless charging field at the harmonic of the fundamental frequency. In various embodiments, the control circuit can be further configured to cause the switching circuit to reconnect the communication circuit to the receive coil in response to determining that the wireless charging field can be no longer present.

In various embodiments, the apparatus can further include a wireless power receive circuit configured to receive wireless power from the wireless power transmitter via the wireless charging field. The switching circuit can be further configured to electrically connect and disconnect the wireless power receive circuit to the receive coil.

Another aspect provides another method for coexisting with a wireless power transmitter. The method includes detecting a packet transmitted by the wireless power transmitter via modulation of a wireless power charging field. The packet indicates presence of the wireless charging field. The method further includes identifying the presence of the wireless charging field based on detecting the packet. The method further includes electrically disconnecting a communication circuit from a receive coil in response to identifying the presence of the wireless charging field.

In various embodiments, the packet can include an amplitude shift keying modulation of the wireless charging field. In various embodiments, the packet can include a first portion having a length of 8 bits and a parity bit appended to the end of the first portion. In various embodiments, the method can further include electrically connecting the communication circuit to the receive coil in an initial state.

In various embodiments, the wireless charging field can oscillate at a fundamental frequency and can carry sufficient energy at a harmonic of the fundamental frequency to accurately identify the presence of the wireless charging field at the harmonic of the fundamental frequency. In various embodiments, the method can further include reconnecting the communication circuit to the receive coil in response to determining that the wireless charging field can be no longer present. In various embodiments, the method can further include electrically connecting a wireless power receive circuit to the receive coil, and receiving wireless power from the wireless power transmitter via the wireless charging field.

Another aspect provides another non-transitory computer-readable medium. The medium includes code that, when executed, causes an apparatus, for coexistence with a wireless power transmitter, to detect a packet transmitted by the wireless power transmitter via modulation of a wireless power charging field. The packet indicates presence of the wireless charging field. The medium further includes code that, when executed, causes the apparatus to identify the presence of the wireless charging field based on detecting the packet. The medium further includes code that, when executed, causes the apparatus to electrically disconnect a communication circuit from a receive coil in response to identifying the presence of the wireless charging field.

In various embodiments, the packet can include an amplitude shift keying modulation of the wireless charging field. In various embodiments, the packet can include a first portion having a length of 8 bits and a parity bit appended to the end of the first portion. In various embodiments, the medium can further include code that, when executed, causes the apparatus to electrically connect the communication circuit to the receive coil in an initial state.

In various embodiments, the wireless charging field can oscillate at a fundamental frequency and can carry sufficient energy at a harmonic of the fundamental frequency to accurately identify the presence of the wireless charging field at the harmonic of the fundamental frequency. In various embodiments, the medium can further include code that, when executed, causes the apparatus to reconnect the communication circuit to the receive coil in response to determining that the wireless charging field can be no longer present. In various embodiments, the medium can further include code that, when executed, causes the apparatus to electrically connect a wireless power receive circuit to the receive coil, and receive wireless power from the wireless power transmitter via the wireless charging field.

Another aspect provides another apparatus for coexistence with a wireless power transmitter. The apparatus includes means for detecting a packet transmitted by the wireless power transmitter via modulation of a wireless power charging field. The packet indicates presence of the wireless charging field. The apparatus further includes means for identifying the presence of the wireless charging field based on detecting the packet. The apparatus further includes means for electrically disconnecting a communication circuit from a receive coil in response to identifying the presence of the wireless charging field.

In various embodiments, the packet can include an amplitude shift keying modulation of the wireless charging field. In various embodiments, the packet can include a first portion having a length of 8 bits and a parity bit appended to the end of the first portion. In various embodiments, the communication circuit can be electrically connected to the receive coil in an initial state.

In various embodiments, the wireless charging field can oscillate at a fundamental frequency and can carry sufficient energy at a harmonic of the fundamental frequency for the means for identifying the presence of the wireless charging field to accurately identify the presence of the wireless charging field at the harmonic of the fundamental frequency. In various embodiments, the apparatus can further include means for reconnecting the communication circuit to the receive coil in response to determining that the wireless charging field can be no longer present. In various embodiments, the apparatus can further include means for receiving wireless power from the wireless power transmitter via the wireless charging field, and means for electrically connecting and disconnecting the means for receiving wireless power to the receive coil.

### BRIEF DESCRIPTION OF THE DRAWINGS

FIG. 1 is a functional block diagram of a wireless power transfer system, in accordance with some implementations.

FIG. 2 is a functional block diagram of a wireless power transfer system, in accordance with some other implementations.

FIG. 3 is a schematic diagram of a portion of transmit circuit or receive circuit of FIG. 2 including a transmit or receive coupler, in accordance with some implementations.

FIG. 4 is a diagram of a wireless power transfer system, in accordance with some implementations.

FIG. 5 is a functional block diagram of the wireless power transmitter of FIG. 4, in accordance with some implementations.

FIG. 6 illustrates a packet as described in connection with FIG. 5, in accordance with some implementations.

FIG. 7 is a functional block diagram of portions of a chargeable device, in accordance with one implementation.

FIG. 8 is a functional block diagram of portions of a chargeable device, in accordance with another implementation.

FIG. 9 is a flowchart depicting a method for wirelessly transmitting charging power, in accordance with some implementations.

FIG. 10 is a flowchart depicting a method for coexisting with a wireless power transmitter, in accordance with some implementations.

### DETAILED DESCRIPTION

In the following detailed description, reference is made to the accompanying drawings, which form a part of the present disclosure. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless charging field (e.g., a magnetic field or an electromagnetic field) may be received, captured, or coupled by a “receive coil” to achieve power transfer.

The terminology used herein is for the purpose of describing particular implementations only and is not intended to be limiting on the disclosure. It will be understood that if a specific number of a claim element is intended, such intent will be explicitly recited in the claim, and in the absence of such recitation, no such intent is present. For example, as used herein, the singular forms “a,” “an” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and “including,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

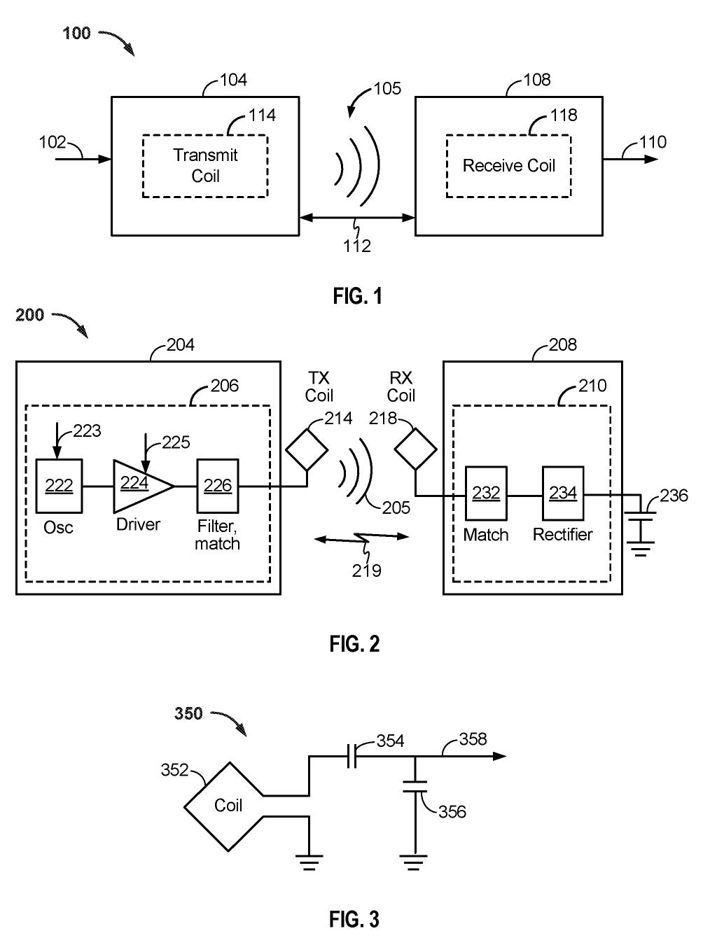

FIG. 1 is a functional block diagram of a wireless power transfer system 100, in accordance with some implementations. Input power 102 may be provided to a transmitter 104 from a power source (not shown) to generate a wireless charging field 105 (e.g., magnetic or electromagnetic) via a transmit coil 114 for performing energy transfer. The receiver 108 may receive power when the receiver 108 is located in the wireless charging field 105 produced by the transmitter 104. The wireless charging field 105 corresponds to a region where energy output by the transmitter 104 may be captured by the receiver 108. A receiver 108 including a receiver coil 118 may couple to the wireless charging field 105 and generate output power 110 for storing or consumption by a device (not shown in this figure) coupled to the output power 110. Both the transmitter 104 and the receiver 108 are separated by a distance 112. Transfer of energy occurs by coupling energy from the wireless charging field 105 of the transmit coil 114 to the receive coil 118, residing in the vicinity of the wireless charging field 105, rather than propagating the energy from the transmit coil 114 into free space.

In one example implementation, power is transferred inductively via a time-varying magnetic field generated by the transmit coil 114. The transmitter 104 and the receiver 108 may further be configured according to a mutual resonant relationship. When the resonant frequency of the receiver 108 and the resonant frequency of the transmitter 104 are substantially the same or very close, transmission losses between the transmitter 104 and the receiver 108 are minimal. Resonant inductive coupling techniques may allow for improved efficiency and power transfer over various distances and with a variety of inductive coil configurations. However, even when resonance between the transmitter 104 and receiver 108 are not matched, energy may be transferred, although the efficiency may be reduced. For example, the efficiency may be less when resonance is not matched.

In some implementations, the wireless charging field 105 corresponds to the “near-field” of the transmitter 104. The near-field may correspond to a region in which there are strong reactive fields resulting from the currents and charges in the transmit coil 114 that minimally radiate power away from the transmit coil 114. The near-field may correspond to a region that is within about one wavelength (or a fraction thereof) of the transmit coil 114. Efficient energy transfer may occur by coupling a large portion of the energy in the wireless charging field 105 to the receive coil 118 rather than propagating most of the energy in an electromagnetic wave to the far field.

FIG. 2 is a functional block diagram of a wireless power transfer system 200, in accordance with some other implementations. The system 200 may be a wireless power transfer system of similar operation and functionality as the system 100 of FIG. 1. However, the system 200 provides additional details regarding the components of the wireless power transfer system 200 as compared to FIG. 1. The system 200 includes a transmitter 204 and a receiver 208. The transmitter 204 includes transmit circuit 206 that includes an oscillator 222, a driver circuit 224, and a filter and matching circuit 226. The oscillator 222 may be configured to generate a signal at a desired frequency (e.g., 6.78 MHz) that may be adjusted in response to a frequency control signal 223. The oscillator 222 provides the oscillator signal to the driver circuit 224. The driver circuit 224 may be configured to drive the transmit coil 214 with an alternating current at a resonant frequency of the transmit coil 214 (e.g., 6.78 MHz) to generate a wireless charging field 205 based on a control signal 225. The wireless charging field 205 can wirelessly transfer power at a level sufficient for charging a battery 236. The filter and matching circuit 226 receives an output of the driver circuit 224, attenuates harmonics or other unwanted frequencies and matches the impedance of the transmit circuit 206 to the impedance of the transmit coil 214.

The receiver 208 comprises receive circuit 210 that includes a matching circuit 232 and a rectifier circuit 234. The matching circuit 232 may match the impedance of the receive circuit 210 to the impedance of the receive coil 218. The rectifier circuit 234 may generate a direct current (DC) power output from an alternate current (AC) power input to charge the battery 236. The receiver 208 and the transmitter 204 may additionally communicate on a separate communication channel 219 (e.g., Bluetooth, Zigbee, NFC, cellular, etc.). The receiver 208 and the transmitter 204 may alternatively communicate via in-band signaling by modulating the wireless charging field 205. In some implementations, the receiver 208 may be configured to determine whether an amount of power transmitted by the transmitter 204 and received by the receiver 208 is appropriate for charging the battery 236.

FIG. 3 is a schematic diagram of a portion of the transmit circuit 206 or the receive circuit 210 of FIG. 2, in accordance with some implementations. As illustrated in FIG. 3, transmit or receive circuit 350 may include a coil 352. The coil 352 may also be referred to or be configured as a “conductor loop”, an inductor, an antenna, or a “magnetic” coil. The term “coil” generally refers to a component that may wirelessly output or receive energy for coupling to another “coil.”

The resonant frequency of the coils is based on the inductance and capacitance of the coil. Inductance may be simply the inductance created by the coil 352, whereas, capacitance may be added via a capacitor 354 (or the self-capacitance of the coil 352) to create a resonant structure at a desired resonant frequency. As a non-limiting example, a capacitor 354 and a capacitor 356 may be added to the transmit or receive circuit 350 to create a resonant circuit that resonates at a resonant frequency. For larger sized coils using large diameter coils exhibiting larger inductance, the value of capacitance needed to produce resonance may be lower. Furthermore, as the size of the coil increases, coupling efficiency may increase. This is mainly true if the size of both transmit and receive coils increase. For transmit coils, the signal 358, with a frequency that substantially corresponds to the resonant frequency of the coil 352, may be an input to the coil 352. For receive coils, the signal 358 may be output for use in powering or charging a load.

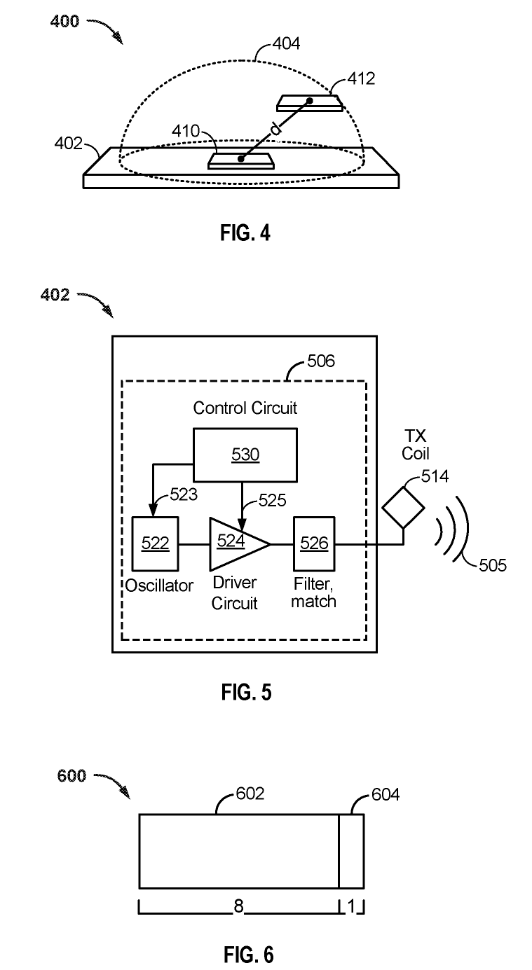

FIG. 4 is a diagram 400 of a wireless power transfer system, in accordance with some implementations. The diagram 400 shows a wireless power transmitter 402 (e.g., a base pad) disposed in a substantially flat, horizontal orientation. The wireless power transmitter 402 is configured to generate a wireless charging field for wirelessly transferring power to chargeable devices in an operating volume 404 over the wireless power transmitter 402. The operating volume 404 generally refers to a volume within which the wireless charging field generated by the wireless power transmitter 402 is sufficiently strong to charge or power a compatible chargeable device. A first chargeable device 410 is shown lying flat on a top surface of the wireless power transmitter 402 and in a position most optimal for receiving wireless power from the wireless power transmitter 402. Such a position may be a substantially central location on the top surface of the wireless power transmitter 402 in some implementations. A second chargeable device 412 is disposed at a distance “d” from the position most optimal for receiving wireless power from the wireless power transmitter 402. For example, a user may be in the process of positioning the second chargeable device 412 in the operating volume 404 of the wireless power transmitter 402 for wireless power transfer. As shown, the first and second chargeable devices 410, 412 are positioned within the operating volume 404 and are therefore under the influence of the wireless charging field generated by the wireless power transmitter 402.

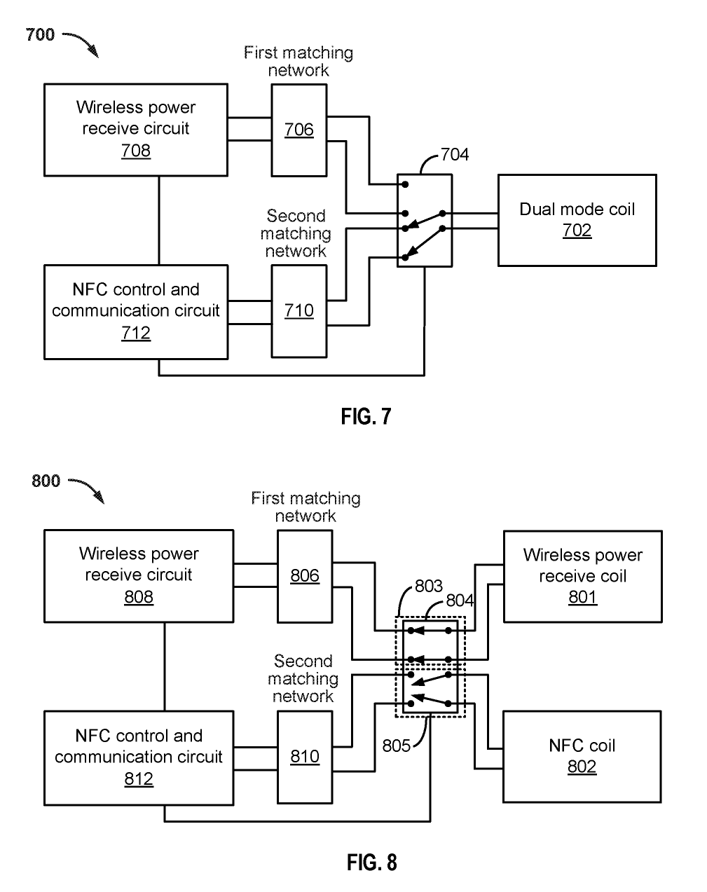

The first and second chargeable devices 410, 412 are also configured to communicate with at least one other wireless device (not shown in FIG. 4) utilizing a communication protocol such as, but not limited to, NFC. In some implementations, the wireless charging field for wireless power transfer may oscillate at a fundamental frequency (e.g., 6.78 MHz). In such implementations, a second harmonic (e.g., 13.56 MHz) of this fundamental frequency may be a frequency at which the first chargeable device 410 and the second chargeable device 412 are also configured to communicate (e.g., via NFC). Thus, energy carried by the wireless charging field at this second harmonic may induce excessive voltage in and cause damage to components of a communication circuit within the first and second chargeable devices 410, 412. Accordingly, features that prevent or significantly limit exposure of the communication circuit within the first and second chargeable devices 410, 412 to such excessive voltages are desirable. As will be described in connection with FIGS. 5 and 6, the wireless power transmitter 402 is configured with features that allow wireless power transfer without damaging communication circuit within the chargeable devices 410, 412. Likewise, as will be described in connection with FIGS. 7 and 8, the first and second chargeable devices 410, 412 are configured with features that allow wireless power transfer without damaging internal communication circuit.

FIG. 5 is a functional block diagram of the wireless power transmitter 402 of FIG. 4, in accordance with some implementations. The wireless power transmitter 402 may further correspond to the wireless power transmitter 204 of FIG. 2. Corresponding components between FIG. 2 and FIG. 5 have the same numerals, however beginning with a “2” in FIG. 2 and beginning with a “5” in FIG. 5. The wireless power transmitter 402 comprises transmit circuit 506 configured to drive a transmit coil 514 with an alternating current to generate a wireless charging field 505. The transmit circuit 506 includes an oscillator 522 having an output connected to an input of a driver circuit 524. The output of the driver circuit 524 is connected to an input of a filter and matching circuit 526. An output of the filter and matching circuit 526 is connected to the transmit coil 514. Each of the oscillator 522, the driver circuit 524 and the filter and matching circuit 526 function as previously described for corresponding components in FIG. 2. The wireless power transmitter 402 may further comprise a control circuit 530 configured to control the driver circuit 524 and/or the oscillator 522 via respective control signals 525 and 523.

In some implementations, the wireless power transmitter 402 is configured to transmit a packet in-band, e.g., by modulating the wireless charging field 505, to the first and second chargeable devices 410, 412 (see FIG. 4). Specifically, the control circuit 530 may modulate the wireless charging field 505 by controlling the output of the driver circuit 524 or of the oscillator 522 via the control signals 525 or 523, respectively. Although the wireless charging field 505 may operate at a fundamental frequency (e.g., 6.78 MHz), the second harmonic (e.g., 13.56 MHz) may carry sufficient energy for the first and second chargeable devices 410, 412 to recognize the packet. In some other implementations, the packet may be transmitted out of band, e.g., as a communication separate from the wireless charging field 505. The packet may identify the wireless charging field 505 as a wireless power transfer field and cause the first and second chargeable devices 410, 412 to disconnect communication circuit from associated receive coil(s). In this way, the first and second chargeable devices 410, 412 may avoid damage to their communication circuit due to excessive voltages induced by the wireless charging field 505 during wireless power transfer.

In some implementations, the wireless power transmitter 402 may repeatedly transmit the packet based on a programmable or predetermined interval. In some implementations, the predetermined interval may have a shorter duration (e.g., 10-50 ms) than the NFC poll-plus-listen interval of 100 ms to 500 ms (e.g., a communication interval of an NFC communication circuit). In some implementations, such a poll-plus-listen interval may be a duration utilized by the NFC communication circuit of the first and/or second chargeable devices 410, 412 to send a communication command and wait to receive a reply in response to the communication command. Transmitting the packet repeatedly ensures the first and second chargeable devices 410, 412 are notified of the presence and nature of the wireless charging field 505 without prior knowledge of their presence at any particular time.

In some implementations, the wireless power transmitter 402 may transmit the packet using 100% amplitude shift keying modulation (ASK modulation), e.g., ON/OFF keying. Using 100% ASK modulation has the benefit of being simple and inexpensive to implement by the wireless power transmitter 402. ASK modulation is also beneficial for increasing robustness of detection by the first and second chargeable devices 410, 412. ASK modulation is further beneficial for reducing signal compression or saturation in receiving NFC antennas of the first and second chargeable devices 410, 412.

In some implementations, the wireless power transmitter 402 may be further configured to reduce an amount of peak power wirelessly transmitted during packet transmission. Specifically, the control circuit 530 may be configured to adjust one or both of the control signals 523 and 525 during packet transmission. This adjustment reduces the magnitude of an output of the oscillator 522 or driver circuit 524, respectively, reducing a magnitude of the wireless charging field 505 strength during packet transmission. Reducing the magnitude of the wireless charging field 505 strength may, in turn, prevent voltage saturation of the communication circuit in the chargeable devices. This allows efficient charging of chargeable devices in a position most optimal for receiving wireless power while avoiding voltage saturation in chargeable devices simultaneously entering the operating volume 404 of the wireless power transmitter 402.

FIG. 6 illustrates a packet 600 as previously described in connection with FIG. 5, in accordance with some implementations. It is desirable that the packet 600 be as short as possible to reduce the amount of time required for a receiving chargeable device to recognize the packet while under influence of the wireless charging field 505. In addition, shorter packets are desirable to maintain high charging efficiency since the control circuit 530 may reduce the amount of wireless power transmitted during packet transmission. Accordingly, in some implementations, the packet 600 may be a 9 bit packet comprising a first portion 602 having a length of one byte (8 bit), and a single parity bit 604 appended to the end of the packet 600. The first portion 602 may comprise a bit sequence that identifies the wireless charging field 505 (see FIG. 5) as a wireless power transfer field and causes receiving chargeable devices to disconnect communication (e.g., NFC) circuit from associated receive coil(s). In some implementations, the parity bit 604 may have a value of “0”.

Since NFC communication circuits may utilize energy received via wireless charging fields for internal power, the wireless power transmitter 402 may generate the wireless charging field 505 for at least a first interval of time (e.g., 5 ms) to give NFC circuit in a receiving chargeable device enough time to “wake up”. After at least this first interval of time, the wireless power transmitter 402 may begin to transmit the packet 600 in-band by turning the wireless charging field 505 ON (to transmit a “1”) and OFF (to transmit a “0”). In some implementations, the duration of ON or OFF intervals may be 9.44 μs or integer multiples thereof in order to transmit a string of “1s” and “0s” that form the packet 600. Thus, for an example 9 bit packet 600, the total packet duration may be approximately 85 μs.

FIG. 7 is a functional block diagram of portions of a chargeable device 700, in accordance with one implementation. In some implementations, the chargeable device 700 may correspond to either of the first and second chargeable devices 410, 412 previously described in connection with FIG. 4. The chargeable device 700 may include a dual mode coil 702 (e.g., antenna) connected to a switching circuit 704. The dual mode coil 702 is configurable to receive wireless power from the wireless power transmitter 402 and also to receive and transmit communications via NFC protocols. One benefit of a single shared antenna (e.g., the dual mode coil 702) is reduced coil area compared with the use of separate antennas or coils.

The switching circuit 704 is configured to electrically connect the dual mode coil 702 to one of a first matching network 706 or a second matching network 710. The first matching network 706 may be electrically connected between wireless power receive circuit 708 and the switching circuit 704. The first matching network 706 is configured to match the impedance of the wireless power receive circuit 708 to the impedance of the dual mode coil 702. In some implementations, the first matching network 706 and the wireless power receive circuit 708 may collectively correspond to the receive circuit 210 previously described in connection with FIG. 2. The second matching network 710 may be electrically connected between NFC control and communication circuit 712 and the switching circuit 704. The second matching network 710 is configured to match the impedance of the NFC control and communication circuit 712 to the impedance of the dual mode coil 702. The NFC control and communication circuit 712 is configured to control the switching circuit 704 to electrically connect the dual mode coil 702 to the wireless power receive circuit 708 or to the NFC control and communication circuit 712. In some implementations, the NFC control and communication circuit 712 may comprise or represent both a control circuit and a communication circuit. In some other implementations, the control circuit and the communication circuit may be physically separate from one another.

According to some NFC protocols, a compatible device is ready to receive NFC communications as soon as 2.5 ms after wireless charging field reset. If the switching circuit 704 is connected to the wireless power receive circuit 708 in an initial state, the chargeable device 700 may not be able to comply with such strict NFC interoperability requirements. This is especially true where firmware latency and settling to steady state of the NFC control and communication circuit 712 are considered. Thus, in some implementations, the switching circuit 704 may be configured to connect the dual mode coil 702 to the NFC control and communication circuit 712 in an initial state.

In some implementations, the NFC control and communication circuit 712 may have an operating voltage range of approximately 50 mV-30V peak to peak (pp). However, the second harmonic of the wireless charging field 505 may induce voltages at the NFC control and communication circuit 712 of approximately 35 Vpp when the chargeable device 700 is located within the operating volume 404 (see FIG. 4). The NFC control and communication circuit 712 may also mistake these excessive induced voltages for the presence of an NFC reader and, in target mode, wake up the NFC receive circuit at inappropriate times, exposing it to damage. Static sequencing of the switching circuit 704 may not be able to guarantee protection if the chargeable device 700 enters the operating volume 404 (see FIG. 4) during an NFC-connected portion of the sequence. Accordingly, it is desirable to isolate the effects of the wireless charging field 505 from the NFC control and communication circuit 712 by some other method.

When the wireless power transmitter 402 transmits the packet 600 (see FIG. 6) in the wireless charging field 505 (see FIG. 5), a voltage is induced in the dual mode coil 702. The switching circuit 704 electrically connects this induced voltage to the NFC control and communication circuit in the initial state. The NFC control and communication circuit 712 is configured to recognize the induced voltage pattern associated with the packet 600 and identify the wireless charging field 505 as a wireless power transfer field. The NFC control and communication circuit 712 may then cause the switching circuit 704 to disconnect the dual mode coil 702 from the NFC control and communication circuit 712. This may include causing the switching circuit 704 to switch electrical connection of the dual mode coil 702 from the NFC control and communication circuit 712 to the wireless power receive circuit 708. When the wireless charging field 505 is no longer sensed, the NFC control and communication circuit 712 may cause the switching circuit 704 to switch back to its initial state, i.e., electrically connecting the dual mode coil 702 to the NFC control and communication circuit 712. In such implementations, the NFC control and communication circuit 712 may already be electrically disconnected from the dual mode coil 702 by the switching circuit 704. Accordingly, the wireless power receive circuit 708 may indicate to the NFC control and communication circuit 712 that the wireless charging field 505 is no longer present in response to no longer receiving wireless power via the dual mode coil 702. In other implementations, a control circuit of the NFC control and communication circuit 712 may be directly electrically connected to the dual mode coil 702 (not shown) in order to directly detect that the wireless charging field 505 is no longer present. In such implementations, the switching circuit 704 may be configured to electrically connect and disconnect only a communication circuit portion of the NFC control and communication circuit 712 from the dual mode coil 712. In some implementations, after causing the switching circuit 704 to switch its electrical connection, the NFC control and communication circuit 712 may enter a sleep mode in order to save additional power. In this implementation, such a solution addresses previously described challenges without the need for additional hardware, such as a 6.75 MHz energy detector, mode switch logic, or the like. In some other implementations, such an energy detector or mode switch logic may be used.

In some embodiments, a receiver device (such as the chargeable device 700) can be configured for coexistence with a wireless power transmitter, but may not include a receive coil or associated wireless power circuitry. For example, the wireless power receive circuit 708 can be omitted. Thus, a receiver device (such as the chargeable device 700) can include only NFC components, but can retain circuitry to detect the packet and disconnect itself.

FIG. 8 is a functional block diagram of portions of a chargeable device 800, in accordance with another implementation. The chargeable device 800 may be substantially the same as the chargeable device 700 of FIG. 7, except for having a wireless power receive coil 801 and a separate NFC coil 802, each connected to a switching circuit 804. Unless otherwise mentioned, each component of the chargeable device 800 has the same functionality as the corresponding component in the chargeable device 700. The switching circuit 804 may have a dedicated circuit 803 for connecting and disconnecting the wireless power receive coil 801 and the wireless power receive circuit 808. The switching circuit 804 may also have a dedicated circuit 805 for connecting and disconnecting the NFC coil 802 and the NFC control and communication circuit 812. The NFC control and communication circuit 812 may function as previously described for the NFC control and communication circuit 712, however separately controlling the dedicated circuits 803, 805 of the switching circuit 804.

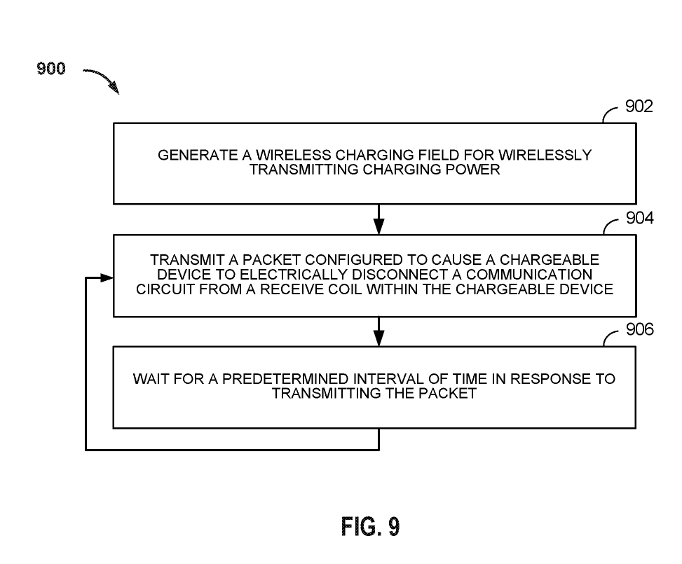

FIG. 9 is a flowchart 900 depicting a method for wirelessly transmitting charging power, in accordance with some implementations. For example, the flowchart 900 may correspond to the previous description regarding FIGS. 4-6 above.

Flowchart 900 may begin with block 902, which includes generating a wireless charging field for wirelessly transmitting charging power. For example, as previously described in connection with FIG. 4, the wireless power transmitter 402 is configured to generate a wireless charging field for wirelessly transferring power.

Block 904 includes transmitting a packet configured to cause a chargeable device to electrically disconnect a communication circuit from a receive coil within the chargeable device. The packet may have a structure and/or include information indicative of the presence of the wireless charging field or otherwise convey information regarding characteristics of the wireless charging field. For example, as previously described in connection with FIG. 5, the wireless power transmitter 402 is configured to transmit a packet in-band, e.g., by modulating the wireless charging field 505. The wireless power transmitter 402 may also or alternatively be configured to transmit the packet out of band, e.g., as a communication separate from the wireless charging field 505. The transmission of the packet may be coordinated/concurrent with the generation of the wireless charging field.

Block 906 includes waiting for a predetermined interval of time in response to transmitting the packet. The flowchart 900 may then loop back to block 904, where the packet is transmitted again (e.g., periodically). For example, as previously described in connection with FIG. 5, the wireless power transmitter 402 may repeatedly transmit the packet based on a programmable or predetermined interval concurrent with the generation of the wireless charging field. As described above, in accordance with implementations where the packet is transmitted in-band via modulation of the wireless charging field, the wireless power transmitter 402 may be configured to alter one or more characteristics of the wireless power charging field (e.g., reduce the overall wireless charging field strength) during transmission of the packet.

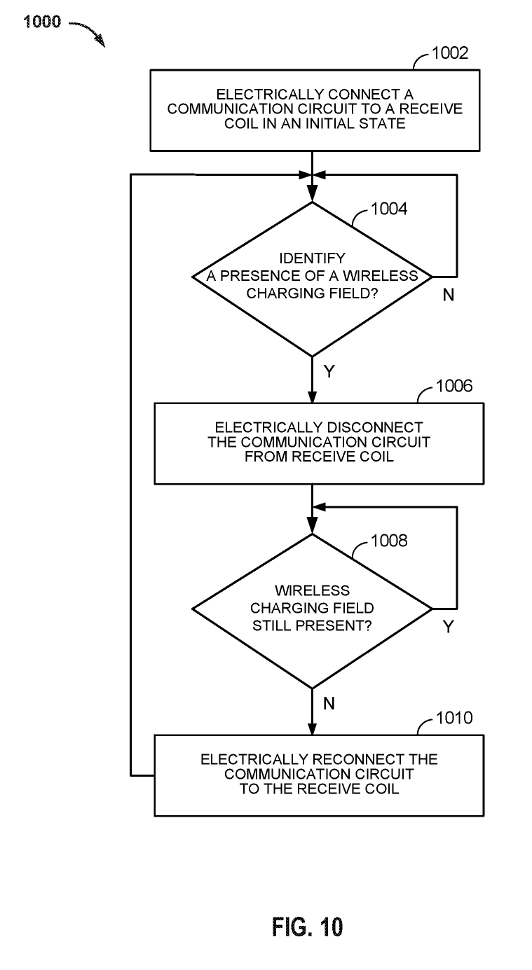

FIG. 10 is a flowchart 1000 depicting a method for coexisting with a wireless power transmitter, in accordance with some implementations. For example, the flowchart 1000 may correspond to the previous description regarding FIGS. 4 and 7-8 above.

Flowchart 1000 may begin with block 1002, which includes electrically connecting a communication circuit to a receive coil in an initial state. For example, as previously described in connection with the chargeable device 700 of FIG. 7, the switching circuit 704 may be configured to connect the dual mode coil 702 to the NFC control and communication circuit 712 in an initial state. Flowchart 1000 may then advance from block 1002 to decision block 1004.

Decision block 1004 includes determining whether a presence of a wireless charging field is identified. For example, as previously described in connection with the chargeable device 700 of FIG. 7, the NFC control and communication circuit 712 is configured to recognize the packet 600 and identify the wireless charging field 505 as a wireless power transfer field. In some implementations, the packet is detected by the chargeable device 700 via detection of modulated information transmitted by a wireless power transmitter that is generating a wireless power charging field (e.g., in some implementations via modulation of the wireless charging field). If a presence of a wireless charging field is not identified, flowchart 1000 loops back to decision block 1004. If a presence of a wireless charging field is identified, flowchart 1000 advances from decision block 1004 to block 1006.

Block 1006 includes electrically disconnecting the communication circuit from the receive coil. For example, as previously described in connection with the chargeable device 700 of FIG. 7, the NFC control and communication circuit 712 causes the switching circuit 704 to disconnect the dual mode coil 702 from the NFC control and communication circuit 712. The flowchart 1000 advances from block 1006 to decision block 1008.

Decision block 1008 includes determining whether the wireless charging field is still present. For example, as previously described in connection with the chargeable device 700 of FIG. 7, the wireless power receive circuit 708 may indicate to the NFC control and communication circuit 712 that the wireless charging field 505 is no longer present. In other implementations, a control circuit of the NFC control and communication circuit 712 may be directly electrically connected to the dual mode coil 702 (not shown) in order to directly detect that the wireless charging field 505 is no longer present. If the wireless charging field is still present, flowchart 1000 loops back to decision block 1008. If the wireless charging field is not still present, flowchart 1000 advances from decision block 1008 to block 1010.

Block 1010 includes electrically reconnecting the communication circuit to the receive coil. For example, as previously described in connection with the chargeable device 700 of FIG. 7, when the wireless charging field 505 is no longer sensed, the NFC control and communication circuit 712 may cause the switching circuit 704 to electrically reconnect the dual mode coil 702 to the NFC control and communication circuit 712. Flowchart 1000 may then loop back to decision block 1004.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations. For example, in some implementations, the transmit coil 514 may also be known as, or may comprise at least a portion of means for generating a wireless charging field for wirelessly transmitting charging power. The control circuit 530 and/or the transmit coil 514 may also be known as, or may comprise at least a portion of means for transmitting a packet via the wireless charging field, and/or means for transmitting the packet periodically based on a predetermined interval. The control circuit 530 may also be known as, or may comprise at least a portion of means for reducing a peak magnitude of a strength of the wireless charging field during packet transmission. In some other implementations, at least a portion of the NFC control and communication circuits 712, 812 may also be known as, or comprise at least a portion of means for identifying a presence of a wireless charging field. The switching circuits 704, 804 may also be known as, or comprise at least a portion of means for electrically disconnecting a communication circuit from a receive coil in response to identifying the presence of the wireless charging field. The switching circuits 704, 804 may also be known as, or comprise at least a portion of means for reconnecting the communication circuit to the receive coil, and/or means for electrically connecting and disconnecting the means for receiving wireless power to the receive coil. The wireless power receive circuits 708, 808 and/or the coils 702, 801, 802 may also be known as, or comprise at least a portion of means for receiving wireless power from the wireless power transmitter.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. When executed, the code may cause an apparatus to perform one or more actions, steps, or functions. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media. The processor and the storage medium may reside in an ASIC.

For purposes of summarizing the disclosure, certain aspects, advantages and novel features have been described herein. It is to be understood that not necessarily all such advantages may be achieved in accordance with any particular implementation. Thus, one or more implementations achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the application. Thus, the present application is not intended to be limited to the implementations shown herein but is to be accorded the widest scope consistent with the principles and novel features disclosed herein.

What is claimed is:

1. An apparatus for wirelessly transmitting charging power, the apparatus comprising:
a transmit coil configured to generate a wireless charging field for wirelessly transmitting charging power when driven by a current; and
a control circuit configured to modulate the wireless charging field for transmission of a packet via the wireless charging field, wherein the packet comprises information indicative of the presence of the wireless charging field to cause a chargeable device to electrically disconnect a communication circuit from a receive coil within the chargeable device,
wherein the transmit coil is further configured to transmit the packet via the wireless charging field.

2. The apparatus of claim 1, wherein the control circuit is further configured to cause the transmit coil to transmit the packet periodically based on a predetermined interval.

3. The apparatus of claim 2, wherein the predetermined interval has a shorter duration than a duration utilized by the communication circuit to send a communication command and wait to receive a reply in response to the communication command.

4. The apparatus of claim 1, wherein the wireless charging field oscillates at a fundamental frequency and carries sufficient energy at a harmonic of the fundamental frequency for the chargeable device to accurately identify the packet at the harmonic of the fundamental frequency.

5. The apparatus of claim 1, wherein the control circuit is further configured to cause the transmit coil to transmit the packet as an amplitude shift keying modulation of the wireless charging field.

6. The apparatus of claim 1, wherein the packet comprises a first portion having a length of 8 bits and a parity bit appended to the end of the first portion.

7. The apparatus of claim 1, wherein the control circuit is further configured to reduce a magnitude of a strength of the wireless charging field during packet transmission.

8. A method for wirelessly transmitting charging power, the method comprising:
generating a wireless charging field for wirelessly transmitting power;
modulating the wireless charging field for transmission of a packet via the wireless charging field, wherein the packet comprises information indicative of the presence of the wireless charging field to cause a chargeable device to electrically disconnect a communication circuit from a receive coil within the chargeable device; and
transmitting the packet via the wireless charging field.

9. The method of claim 8, wherein the packet is transmitted periodically based on a predetermined interval.

10. The method of claim 9, wherein the predetermined interval has a shorter duration than a duration utilized by the communication circuit to send a communication command and wait to receive a reply in response to the communication command.

11. The method of claim 8, wherein the wireless charging field oscillates at a fundamental frequency and carries sufficient energy at a harmonic of the fundamental frequency for the chargeable device to accurately identify the packet at the harmonic of the fundamental frequency.

12. The method of claim 8, wherein modulating the wireless charging field comprises modulating the wireless charging field using amplitude shift keying modulation.

13. The method of claim 8, wherein the packet comprises a first portion having a length of 8 bits and a parity bit appended to the end of the first portion.

14. The method of claim 8, further comprising reducing a magnitude of a strength of the wireless charging field while transmitting the packet.

15. An apparatus for coexistence with a wireless power transmitter, the apparatus comprising:
a control circuit configured to:
detect a packet transmitted by the wireless power transmitter via modulation of a wireless power charging field, the packet indicating presence of the wireless charging field; and
identify the presence of the wireless charging field based on detecting the packet; and
a switching circuit configured to electrically disconnect a communication circuit from a receive coil in response to identifying the presence of the wireless charging field.

16. The apparatus of claim 15, wherein the control circuit causes the switching circuit to electrically disconnect the communication circuit from the receive coil in response to identifying the presence of the wireless charging field.

17. The apparatus of claim 16, wherein the packet comprises an amplitude shift keying modulation of the wireless charging field.

18. The apparatus of claim 16, wherein the packet comprises a first portion having a length of 8 bits and a parity bit appended to the end of the first portion.

19. The apparatus of claim 15, wherein the switching circuit is configured to electrically connect the communication circuit to the receive coil in an initial state.

20. The apparatus of claim 15, wherein the wireless charging field oscillates at a fundamental frequency and carries sufficient energy at a harmonic of the fundamental frequency for the control circuit to accurately identify the presence of the wireless charging field at the harmonic of the fundamental frequency.

21. The apparatus of claim 15, wherein the control circuit is further configured to cause the switching circuit to reconnect the communication circuit to the receive coil in response to determining that the wireless charging field is no longer present.

22. The apparatus of claim 15, further comprising a wireless power receive circuit configured to receive wireless power from the wireless power transmitter via the wireless charging field, wherein the switching circuit is further configured to electrically connect and disconnect the wireless power receive circuit to the receive coil.

23. A method for coexisting with a wireless power transmitter, the method comprising:
detecting a packet transmitted by the wireless power transmitter via modulation of a wireless power charging field, the packet indicating presence of the wireless charging field;
identifying the presence of the wireless charging field based on detecting the packet; and
electrically disconnecting a communication circuit from a receive coil in response to identifying the presence of the wireless charging field.

24. The method of claim 23, wherein the packet comprises an amplitude shift keying modulation of the wireless charging field.

25. The method of claim 23, wherein the packet comprises a first portion having a length of 8 bits and a parity bit appended to the end of the first portion.

26. The method of claim 23, further comprising electrically connecting the communication circuit to the receive coil in an initial state.

27. The method of claim 23, wherein the wireless charging field oscillates at a fundamental frequency and carries sufficient energy at a harmonic of the fundamental frequency to accurately identify the presence of the wireless charging field at the harmonic of the fundamental frequency.

28. The method of claim 23, further comprising reconnecting the communication circuit to the receive coil in response to determining that the wireless charging field is no longer present.

29. The method of claim 23, further comprising:
electrically connecting a wireless power receive circuit to the receive coil; and
receiving wireless power from the wireless power transmitter via the wireless charging field.
